(19) United States
(12) Patent Application Publication
(10) Pub. No.: US 2017/0295766 A1
(43) Pub. Date: Oct. 19, 2017

(54) Removable Fins

(71) Applicant: Don Talbot, Wenatchee, WA (US)

(72) Inventor: Don Talbot, Wenatchee, WA (US)

(21) Appl. No.: 15/098,644

(22) Filed: Apr. 14, 2016

(51) Int. Cl. A01K 85/18; A01K 85/01

(52) U.S. Cl. CPC A01K 85/18; A01K 85/01

(57) ABSTRACT

Removable fins may fit via a compression or snap fitting on a flasher, allowing fishers to quickly and easily remove and replace fins. Removable Fins may improve fishing performance by allowing a fisher to adjust attributes of a flasher, allowing the fisher to select revolutions per minute and whether it the flasher will cease rotation at a lower current speed.

### FIELD

This disclosure relates generally to removable fins.

### BACKGROUND

Fishermen may use fish attractors, such as flashers, to capture the attention of fish in a body of water. A flasher may attach to a fishing line with lures, bait, and hooks. A flasher may mimic feeding fish by reflecting light, prompting surrounding fish to investigate. A fin may enhance a flasher's movement in water. Flashers with traditional fixed fins, which may be made in one piece or be coupled by screws, for example, lack versatility and ease of use for fishermen in the field.

### SUMMARY

The instant application discloses, among other things, Removable Fins, which may couple to a flasher by compression fit. In one embodiment, Removable Fins may, for example, be snap into place by a bump fitted into a slot, or may wedge into a slot and be held in place by friction. Removable Fins may allow fishers to quickly and easily remove and replace fins in the field, for example, to adapt to changing water conditions, time of day, or species sought. Removable Fins may improve fishing performance by allowing a fisher to adjust attributes of a flasher, allowing the fisher to select revolutions per minute and whether it the flasher will cease rotation at a lower current speed.

A person skilled in the art will appreciate that Removable Fins may be configured for use with various fishing devices and may be made of any combination of polymers, plastic, nylon, rubber, silicone, metal, or other materials. Removable Fins may also be made in various colors, shapes, sizes, and textures.

### BRIEF DESCRIPTION OF THE DRAWINGS

FIG. 1 illustrates Removable Fins according to one embodiment.

FIG. 2 illustrates Removable Fins according to another embodiment.

FIG. 3 illustrates another view of Removable Fin 100 according to one embodiment.

FIG. 4 illustrates Removable Fins according to yet another embodiment.

FIG. 5 illustrates Removable Fins according to yet another embodiment.

FIG. 6 illustrates Removable Fins according to yet another embodiment.

### DETAILED DESCRIPTION

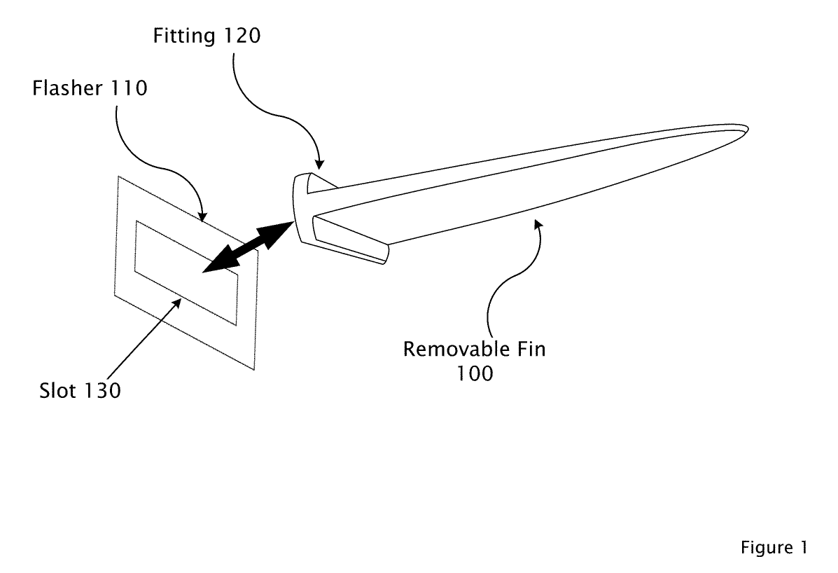

FIG. 1 illustrates Removable Fin 100 according to one embodiment. Removable Fin 100 may couple to a flasher by compression (also known as interference) fit. For example, Removable Fins 100 may include a Fitting 120 which may compress into Slot 130 on Flasher 110. In another embodiment Fitting 120 may be slightly larger than Slot 130, for example, and may snap into place. One having skill in the art will recognize that various ways of attaching a removable fin may be used. A fisher may pull Flasher 110 or Removable Fin 100 apart for quick and easy detachment. Removable Fin 100 may enable a fisherman to adapt to changing water conditions, time of day, or species sought.

Removable Fin 100 may enhance fishing performance by changing attributes of Flasher 110. For example, Removable Fin 100 may be selected to allow a flasher to perform more revolutions per minute, to cease rotations at a lower current speed, or to produce more spin, lift, vibration, or thump action. In one embodiment, Removable Fin 100 may allow Flasher 110 to perform approximately 68 revolutions per minute instead of 58 revolutions per minute in water having a current speed of 2 miles per hour. Removable Fin 100 may allow Flasher 110 to cease rotation in water having a lower current speed; for example, approximately 1 miles per hour instead of 1.5 miles per hour. Removable Fin 100 may produce approximately 30% more thump action over a flasher with a traditional fixed fin. Removable Fin 100 may be a fin which is larger than fixed fins on traditional flashers without compromising performance and durability.

A person skilled in the art will appreciate that Removable Fin 100 may be used with one or more other fishing devices. Removable Fin 100 may be made of any combination of materials, for example, polymers, plastic, nylon, rubber, silicone, metal. Removable Fin 100 may have various shapes, sizes, and textures; for instance, they may have a smooth or hammered finish, or a combination. Removable Fin 100 may have any color, for example, colors in the visible light spectrum, fluorescent colors, or ultraviolet colors. For example, a fisherman may use Removable Fin 100 which display a powerful glow in early morning or evening hours, when water clarity may be darker, or in greater depths, for example, 100 feet below the surface. Removable Fin 100 with a shiny reflection may be used during the day or in shallow water to attract more fish. A clear fin may be used if fish don't respond well to flash or glow.

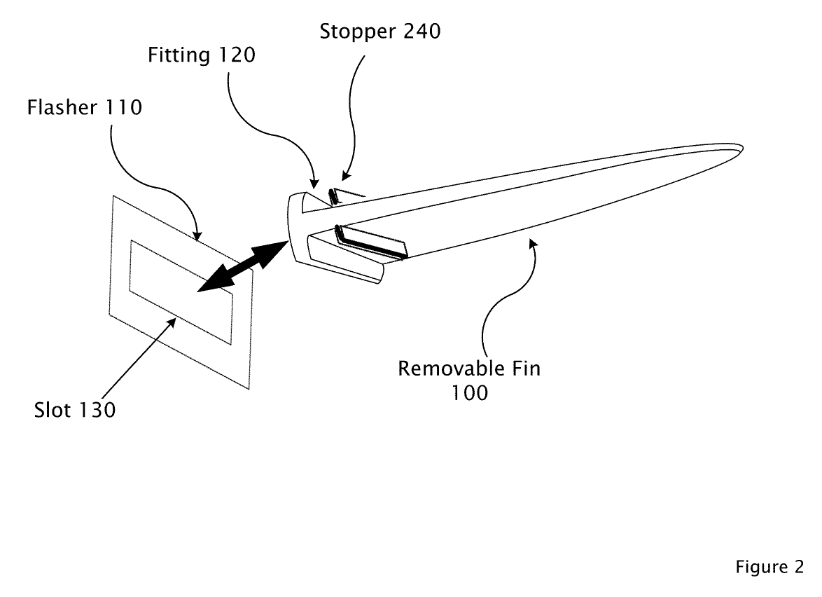

FIG. 2 illustrates Removable Fins according to another embodiment. Removable Fin 100 may be pressed into Slot 130 formed by Flasher 110. Fitting 120 may slide snugly into Slot 130 until Stopper 240 is reached, with Flasher 110 gripping Removable Fin 100 between Fitting 120 and Stopper 240.

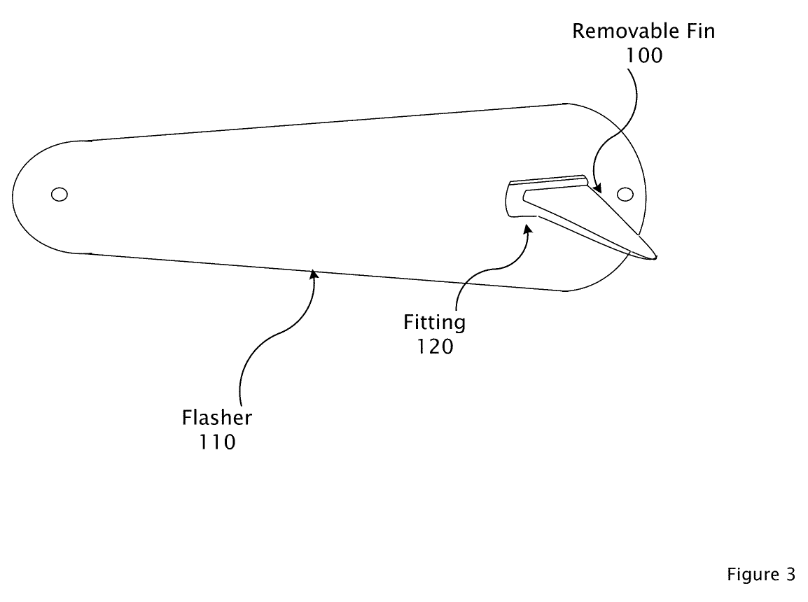

FIG. 3 illustrates another view of Removable Fin 100 according to one embodiment. Removable Fin 100 may couple to Flasher 110 by compression fit, for example, by means of Fitting 120 which may have one or more bumps, wedges, teeth, or slots.

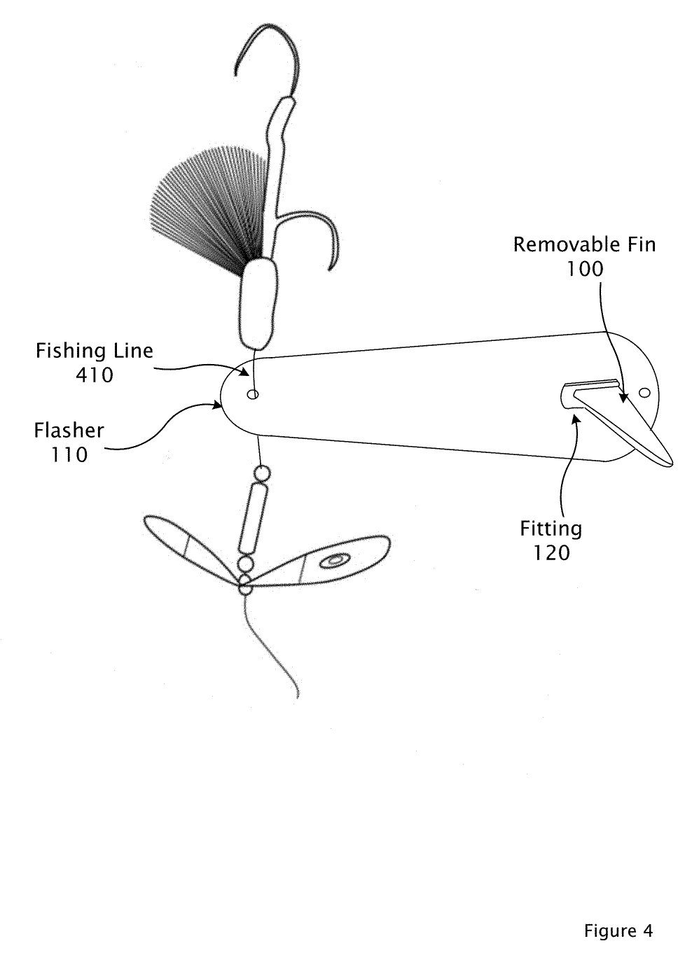

FIG. 4 illustrates Removable Fin according to yet another embodiment. Removable Fin 100 may be coupled to Flasher 110 by Fitting 120 using a compression means. Flasher 110 may attach to Fishing Line 410, which may contain lures, bait, and hooks, for example. A person skilled in the art will appreciate that Removable Fin 100 may be configured for use with various fishing devices.

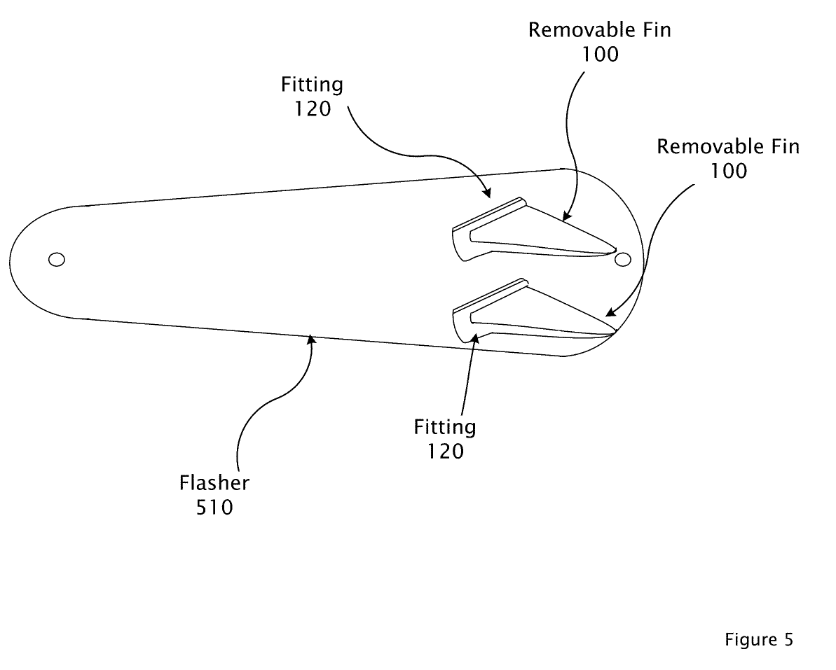

FIG. 5 illustrates Removable Fins according to yet another embodiment. In this example, two Removable Fins 100 may be used on one Flasher 510, which may provide additional control over attributes of Flasher 510. For example, Removable Fins 100 may be selected to allow a flasher to perform more revolutions per minute, to cease rotations at a lower current speed, or to produce more spin, lift, vibration, or thump action. Removable Fins 100 may be placed at an angle, which may allow Flasher 510 to roll more efficiently.

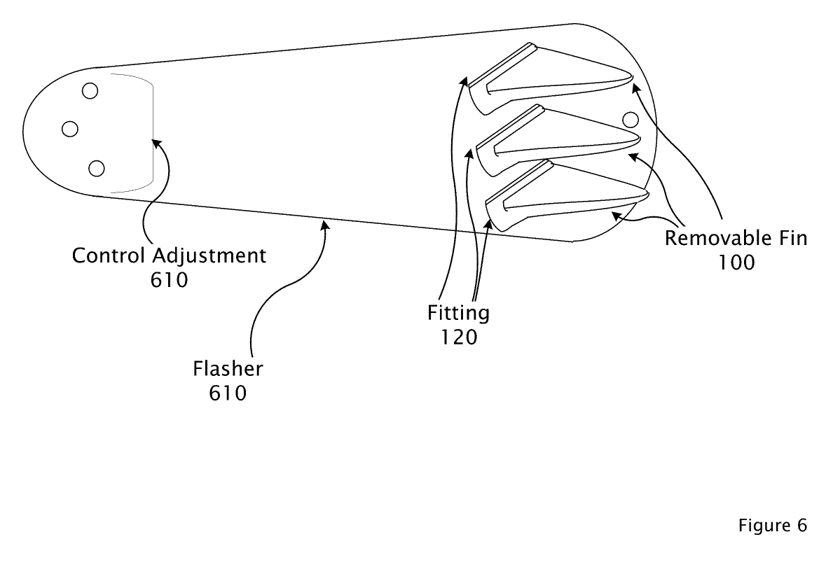

FIG. 6 illustrates Removable Fins according to yet another embodiment. In this example, three Removable Fins 100 may be used on one Flasher 610, which may provide additional control over attributes of Flasher 610. For example, Removable Fin 100 may be selected to allow a flasher to perform more revolutions per minute, to cease rotations at a lower current speed, or to produce more spin, lift, vibration, or thump action. Removable Fins 100 may be placed at an angle, which may allow Flasher 610 to roll more efficiently.

One having skill in the art will recognize that various numbers of fins may be used, and may provide differing attributes.

Control Adjustment 610 may provide additional control over attributes of Flasher 610. By selecting one of various holes formed by Flasher 610, available for a fishing line to pass through Flasher 610, differing revolution paths may be provided. For example, selecting one hole may provide a spiral path with a diameter of approximately two feet, while selecting a different hole may provide a spiral path with a diameter of six feet. One having skill in the art will recognize that various hole locations may provide differing paths and revolution speeds.

1. A fishing attractor, comprising:
a flasher;
a fin;
a fitting, the fitting configured to couple the flasher to the fin by compression or a snap.

2. The fishing attractor of claim 1, wherein the fin is made from a material selected from the list containing polymers, plastic, nylon, rubber, silicone, and metal.

3. The fishing attractor of claim 1, wherein the fin has a smooth finish.

4. The fishing attractor of claim 1, wherein the fin has a hammered finish.

5. The fishing attractor of claim 1, wherein the fin reflects ultraviolet light.

6. The fishing attractor of claim 1, wherein the fin has a fluorescent color.

7. The fishing attractor of claim 1, wherein the fitting comprises elements from the list containing a bump, wedge, tooth, or slot.

8. The fishing attractor of claim 1, wherein the fitting is disposed near an end of the flasher.

9. The fishing attractor of claim 8, wherein the flasher forms a plurality of holes at an end opposite the fitting.
